(19) United States
(12) Patent Application Publication
(10) Pub. No.: US 2004/0147326 A1
(43) Pub. Date: Jul. 29, 2004

(54) Gaming device system

(76) Inventor: Thomas William Stiles, Pocahontas, IL (US)

Correspondence Address: Kirill Y. Abramov, Sonnenschein Nath & Rosenthal LLP, Wacker Drive Station, Sears Tower, P.O. Box #061080, Chicago, IL, 60606-1080, US

(21) Appl. No.: 10/757,324

(22) Filed: Jan. 14, 2004

Related U.S. Application Data
(60) Provisional application No. 60/439,963, filed on Jan. 14, 2003.

(51) Int. Cl. A63F 13/00

(52) U.S. Cl. 463/42

(57) ABSTRACT

A method and apparatus for a gaming device system for casino data tracking. The apparatus includes gaming devices arranged in a bank, a bank hub operatively connected to each of the gaming devices for receiving data from each of the gaming devices, a system hub operatively connected to the bank hub for receiving data from the bank hub, and a tracking device operatively connected to the system hub for receiving data from the system hub.

This application is based upon and claims priority to U.S. Provisional Application No. 60/439,963 filed on Jan. 14, 2003, the contents thereof being incorporated by reference.

### BACKGROUND OF THE INVENTION

1. Field of the Invention

The invention relates generally to gaming devices, and more specifically to a system and method for connecting gaming devices to a casino tracking device to collect data from the gaming devices.

2. Description of the Related Art

Slot machines and other gaming devices are in use in most casinos and account for a significant portion of casino revenue. Usually, several gaming devices are arranged together in banks, and several banks are postured on the casino floor with other familiar games of chance such as roulette and card games. Gaming devices such as slot machines are typically electronic devices and may include an interactive video screen for providing players with gaming entertainment. Players place bets at such gaming devices by depositing coins or tokens in the devices or by inserting a personal player card into the device.

Most casinos use a tracking system including a tracking device operatively connected to the banks of gaming devices. The tracking device is used to monitor the popularity of individual gaming devices, track personal player cards, collect accounting data, detect malfunctions and tampering.

A tracking device can account for revenue collected by each gaming device on the casino floor and allows a casino to report accounting data to state regulatory agencies requiring such data for tax and other purposes. The tracking device also makes it possible for casinos to comply with government revenue tracking requirements for separately monitored gaming devices. Separately monitored gaming devices such as state-wide progressive games, are played simultaneously in several casinos and accumulate and pay a joint jackpot. States regulatory agencies generally require that game revenue from these devices be monitored and reported separately.

Using data collected by the tracking device, a casino can offer its players the most popular gaming devices, compile coin-in and jackpot payout amounts, track the gaming devices accessed with a particular personal player card, track betting habits of individual personal player cards and more. Casinos can use these data to target their marketing services to individual players according to their betting habits. These data are particularly useful for direct-mail campaigns informing players of special casino promotions, upcoming tournaments, complimentary benefits and other casino events.

Tracking systems such as illustrated in FIG. 1 are well known in the art. The system, generally designated by the reference numeral (100), generally consists of a data collection device (102) operatively connected to a bank of gaming devices (104). Within each bank, the gaming devices are connected in series. The connections between the data collection device and the bank of gaming devices and the connections between the devices within the bank are by means of standard commercial cables (106), usually a 3-pair 22-gauge individually shielded cable with drain, such as Belden® type #82777. The interface between the cables and the system hardware is by means of non-modular connectors (108), such as 2-conductor with drain Molex® connectors, male 430243-00 plus pins and female 430452-00 plus pins or equivalent. Because each data collection device can collect data from only a limited number of gaming devices, the number of gaming devices within each bank is limited, usually to between 5 and 32 devices. To make sure data from all gaming devices is collected, the tracking system has multiple data collection devices, each connected to a bank of gaming devices. The data collection devices are connected to a tracking device or computer (not shown) that receives and compiles the data into pre-programmed databases.

Because of changing game popularity and the drive to increase revenues, gaming devices are frequently changed, replaced or moved on the casino floor. During device conversions or repairs, individual gaming devices or entire banks of gaming devices must be taken off-line affecting data transfer of the entire bank and reducing revenue. Conventional cable and connector systems do not permit individual gaming devices or groups of gaming devices to be removed from a tracking system with minimal disruption of data transfer. Also, current cable and connector systems are expensive to install, have limited data bandwidth and are unable to accommodate next-generation interactive gaming devices.

### BRIEF SUMMARY OF THE INVENTION

In one embodiment, this invention provides an apparatus for a gaming device system comprising a plurality of gaming devices arranged in a bank, a bank hub operatively connected to each of the gaming devices in the bank for receiving data from each of the gaming devices, a system hub operatively connected to the bank hub for receiving data from the bank hub, and a tracking device operatively connected to the system hub for receiving data from the system hub, thereby collecting data from the gaming devices.

In another embodiment, this invention provides an apparatus for a gaming device system comprising a first plurality of gaming devices arranged in a first bank, a second plurality of gaming devices arranged in a second bank, a first bank hub operatively connected to each of the gaming devices in the first bank for receiving data from each of the first plurality of gaming devices, a second bank hub operatively connected to each of the gaming devices in the second bank for receiving data from each of the second plurality of gaming devices, a system hub operatively connected to each of the first and second bank hubs for receiving data from the first and second bank hubs, and a tracking device operatively connected to the system hub for receiving data from the system hub, thereby collecting data from the first and second pluralities of gaming devices.

In yet another embodiment, this invention provides an apparatus for a gaming device system comprising a plurality of gaming devices arranged in a bank and connected in series, a separately monitored gaming device capable of transmitting data, an insulation displacement connector operatively connected to each of the plurality of gaming devices in the bank and to the separately monitored gaming device for receiving data from the plurality of gaming devices and the separately monitored gaming device, a patch panel operatively connected to the insulation displacement connector for receiving data from the insulation displacement connector, a plurality of data collection devices connected to the patch panel for receiving data from the plurality of gaming devices and the separately monitored gaming device, and a tracking device operatively connected to each of the plurality of data collection devices for receiving data from the data collection devices, thereby collecting data from the plurality of gaming devices and the separately monitored gaming device.

In another embodiment, the invention provides a method for converting a gaming device system including a bank of gaming devices connected to a modular connector, an insulation displacement connector having a plurality of pairs of wire receptors connected to said modular connector, a patch panel connected to at least one of said pairs of wire receptors, a collection device operatively connected to said patch panel, and a tracking device operatively connected to said collection device, said method comprising disconnecting said bank of gaming devices from said modular connector, connecting the modular connector to a bank hub connected to at least one gaming device, cross-connecting each of said pairs of wire receptors of said insulation displacement connector to said patch panel, connecting said patch panel to a system hub, and connecting said system hub to said tracking device.

In still another embodiment, the invention provides a method for converting a gaming device system including a plurality of banks of gaming devices connected to a plurality of modular connectors, an insulation displacement connector having a plurality of pairs of wire receptors connected to said plurality of modular connectors, a patch panel connected to at least one of said pairs of wire receptors, a collection device operatively connected to said patch panel, and a tracking device operatively connected to said collection device, said method comprising disconnecting each of said plurality of banks of gaming devices from said plurality of modular connectors, connecting at least one of said plurality of modular connectors to a bank hub connected to at least one gaming device, cross-connecting each of said pairs of wire receptors of said insulation displacement connector to said patch panel, connecting said patch panel to a system hub, and connecting said system hub to said tracking device.

In another embodiment, the invention provides a method for converting a gaming device system including a bank of gaming devices connected to a modular connector, an insulation displacement connector connected to said modular connector, said insulation displacement connector having a plurality of pairs of wire receptors, a patch panel including a plurality of panel connectors, at least one of said panel connectors connected to at least one of said pairs of wire receptors, a collection device operatively connected to said patch panel, and a tracking device operatively connected to said collection device, said method comprising disconnecting said bank of gaming devices from said modular connector, connecting a modular adapter to said modular connector, said modular adapter having a plurality of connectors, connecting said bank of gaming devices to one of said plurality of connectors of said adapter, connecting a separately monitored gaming device to another of said plurality of connectors of said adapter, connecting said panel connectors to said pairs of wire receptors of said insulation displacement connector so that said bank of gaming devices and said separately monitored gaming device are in communication with separate panel connectors, connecting a plurality of collection devices to said panel connectors so that said bank of gaming devices and said separately monitored gaming device are in communication with separate collection devices, and connecting each of said collection devices to a tracking device.

In still another embodiment, the invention provides a method of changing devices in a gaming device system including a bank hub having a plurality of gaming device jacks, a plurality of gaming devices connected to said device jacks of said bank hub, said bank hub being in communication with a tracking device, said method comprising, disconnecting at least one of said gaming devices from said plurality of gaming device jacks thereby allowing the other of said plurality of gaming devices to be connected to said bank hub.

Other features of the present invention will be apparent and/or pointed out hereinafter.

### BRIEF DESCRIPTION OF THE SEVERAL VIEWS OF THE DRAWINGS

FIG. 1 is a schematic of a conventional gaming device system.

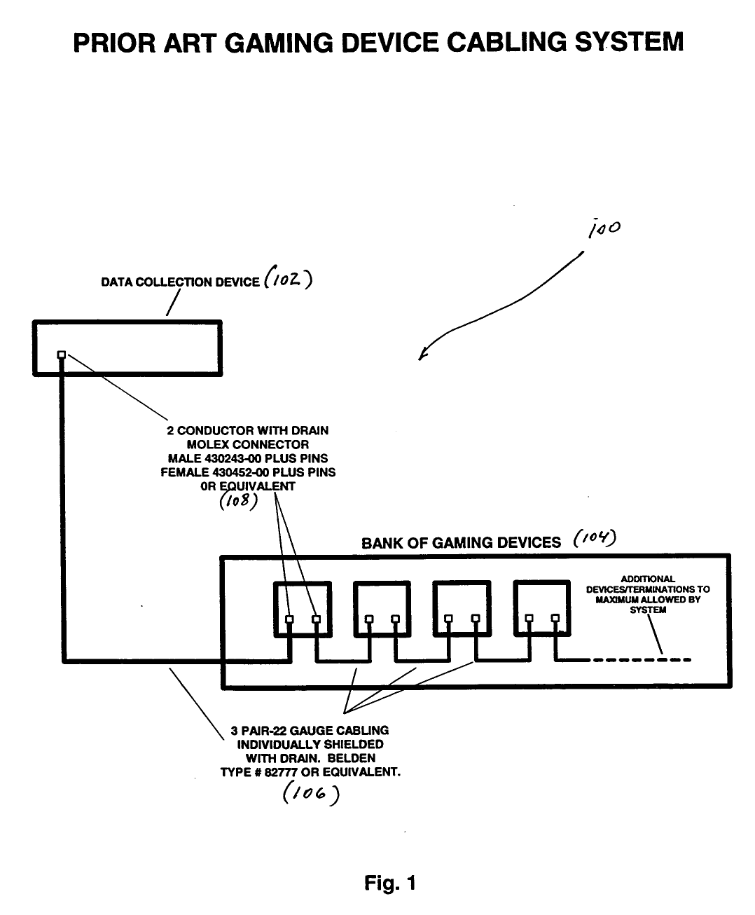

FIG. 2 is a schematic of a first embodiment of the gaming device system of the present invention.

FIG. 3 is a schematic of a second embodiment of the gaming device system of the present invention.

FIG. 4 is a schematic of a third embodiment of the gaming device system of the present invention.

FIG. 5 is a schematic of a forth embodiment of the gaming device system of the present invention.

FIG. 6 is a schematic of a fifth embodiment of the gaming device system of the present invention.

Corresponding reference characters indicate corresponding parts throughout the several views of the drawings.

### DETAILED DESCRIPTION OF THE INVENTION

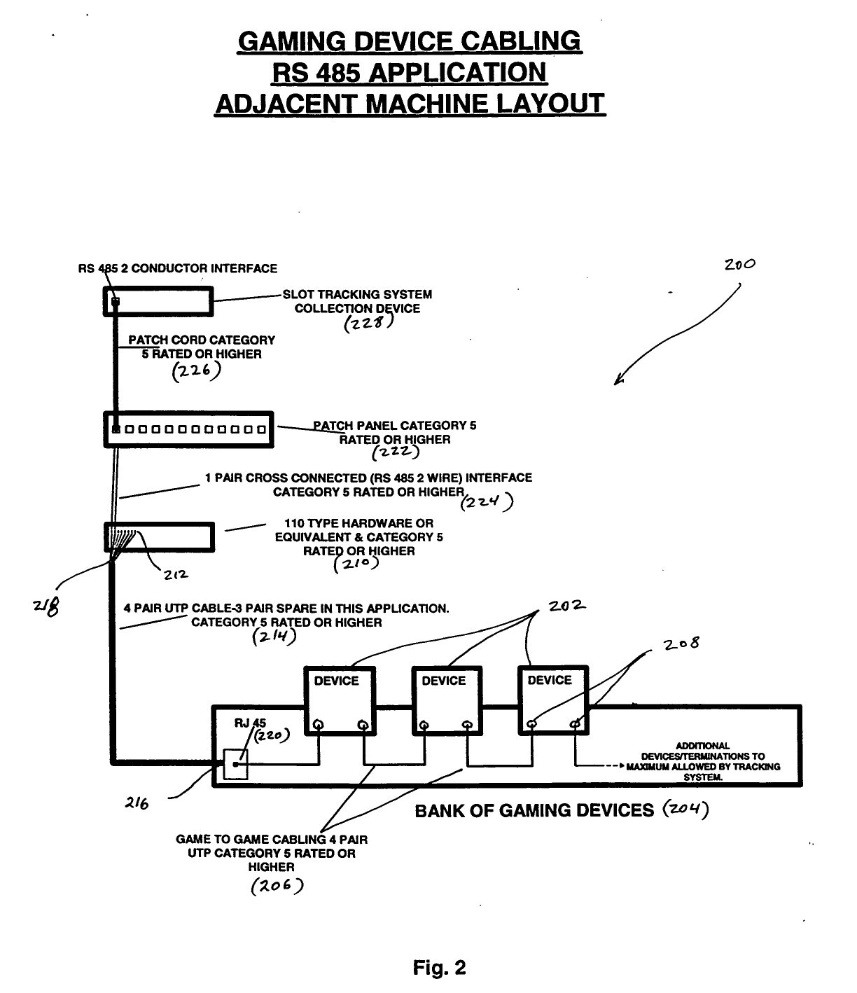

FIG. 2 illustrates an embodiment of a gaming device system configured for RS-485 data transmission applications. RS-485 is a data transmission standard developed by the Electronic Industries Association (“EIA”) and the Telecommunications Industry Association (“TIA”) for a variety of applications. The RS-485 standard is also sometimes referred to as the EIA/TIA-485 standard. The RS-485 standard is preferable for data transmission in master/slave architecture such as a casino data tracking system. The RS-485 standard allows hardware to be connected by lengthy cables, and allows data transfer at a higher rate than older standards such as the RS-232.

FIG. 2 illustrates a gaming device system for casino data tracking designated in its entirety by the reference numeral (200). The system includes a plurality of gaming devices (202) arranged in a bank (204) and connected in series with device patch cords (206) having modular connectors (208). The device patch cords and modular connectors preferably have a EIA/TIA T568-A Standard Category 5 rating or higher. The EIA/TIA T568-A category ratings were developed to rate network hardware according to its data transmission speed. Category 5 and higher rated hardware are capable of data transmission speeds of about 100 MHz and above and include Category 5, Category 5e (enhanced), Category 6 and Category 7(proposed) rated hardware. As used herein, “category-5-compatible” shall be used to describe hardware having a Category 5 rating or higher. The modular connectors (208) may be Molex® multi-pin connectors or equivalent type connectors. The bank of gaming devices is terminated by an RS-485 compatible termination device (not shown) to provide for signal reflection at the end of the bank. Alternatively, a termination device is not needed on gaming devices that have a built-in termination device.

The system includes an insulation displacement connector (210) connected to the bank of gaming devices for receiving gaming device data. The insulation displacement connector is preferably a 110-type hardware or equivalent and is Category-5-compatible. A commercially available 110-type insulation displacement connector such as Panduit® P110 KB1004 may be used. The insulation displacement connector has a plurality (e.g., four pairs) of wire receptors (212). A twisted pair cable (214) connects the bank of gaming devices to the insulation displacement connector. The unshielded twisted pair connector is preferably a 4 -pair unshielded twisted pair cable with a Category-5-compatible. The pairs of wires making up the twisted pair cable (214) have a device end (216) and a system end (218) opposite the device end (216). The system end (218) of each wire pair is connected to a corresponding wire receptors of the insulation displacement connector. The device end (216) of the unshielded twisted pair cable has an RJ-45 modular connector (220) for connecting to the bank of gaming devices. The device end (216) can terminate at a wall, panel or other surface and can have a face plate. The device patch cord of the first gaming device in the bank (204) can plug into the RJ-45 modular connector (220). The RJ-45 modular connector can be mounted and housed in a surface mount box such as Panduit® JPB1IW or equivalent.

The system includes a patch panel (222) operatively connected to the insulation displacement connector for transmitting gaming device data from the insulation displacement connector to the collection device (228). The patch panel is preferably Category-5-compatible. A commercially available patch panel such as the Panduit® DP485E8810u or equivalent may be used. A plurality, but preferably only one pair, of the wire receptors of the insulation displacement connector is cross connected to the patch panel using a single pair twisted connect wire (224) that is Category-5-compatible. Three pairs of the 4-pair twisted cable (214) are idle in the embodiment illustrated in FIG. 2. A system level patch cord (226) connects the patch panel to the collection device. The system level patch cord is preferably Category-5-compatible. A commercially available patch cord such as the Panduite UTPCI78u or equivalent may be used.

The data collection device (228) collects revenue, player card identification, and other data transmitted by the gaming devices. The data collection device transmits the gaming device data to a tracking device (not shown) such as a computer that compiles the gaming device data into pre-programmed databases.

When changing a bank of gaming devices, the device patch cord (206) can be easily unplugged from the RJ-45 modular connector (220). The bank of gaming devices can then be moved to a different place on the casino floor or removed from the casino altogether. Another bank of gaming devices having a device patch cord (206) with a modular connector (208) can be plugged into the RJ-45 connector (220) and data collection can resume.

When a gaming device needs to be repaired or otherwise taken off-line, the device patch cords attached to the device can be removed from the gaming device and connected together using an inline coupler such as a Avaya® 451A-50. Alternatively, an inline coupler can be configured onsite by connecting one RJ-45 connector to another RJ-45 connector, such as Panduit® CJ588IW connectors. The removed gaming device will internally store a limited amount of gaming data that it will transmit to the collection device once it is on-line. Alternatively, an upstream gaming device can be by-passed by unplugging the device patch cords (206) from the upstream device and plugging one of the device patch cords into a downstream device.

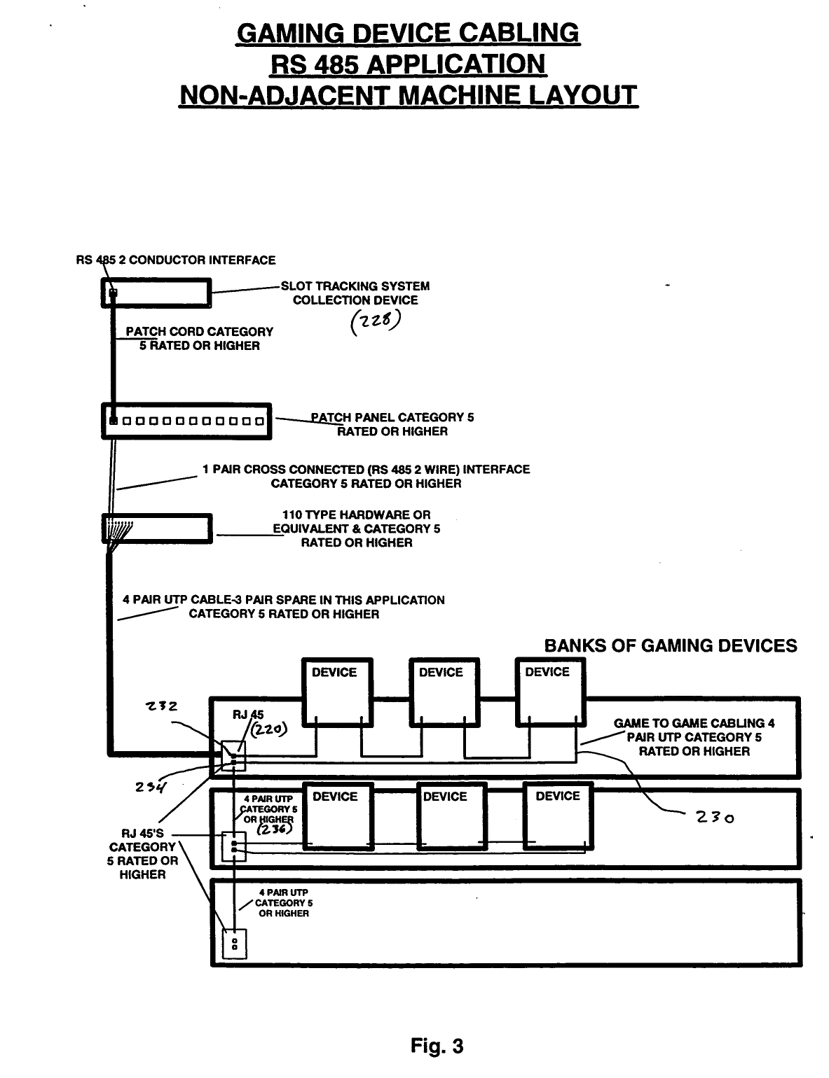

FIG. 3 illustrates an embodiment of the present invention in which multiple banks of gaming devices are configured to transmit data to the collection device (228). In this embodiment, the last gaming device in the bank is connected by a return patch cord (230) to the RJ-45 connector (220), which has an outgoing jack (232) and a return jack (234). The return patch cord connects to the return jack. An interbank cable (236) connects the return jack of one RJ-45 connector with the outgoing jack (232) of another RJ-45 connector associated with a separate bank of gaming devices. Preferably the interbank cable runs behind the face plates of the RJ-45 connectors. The return patch cord and the interbank cable are preferably 4-pair unshielded twisted pair cables. The return patch cord, the RJ-45 connector, and the interbank cable preferably are Category-5-compatible.

As illustrated in FIG. 3, multiple banks of gaming devices may be connected in series on the casino floor. The series is terminated with an RS-485 termination device (not shown) that may be connected to the last gaming device. Alternatively, a termination device is not needed on gaming devices that have a built-in termination device. It will be readily apparent to those skilled in the art that a patch panel can be configured to connect to multiple twisted pair wires associated with multiple insulation displacement connectors connected to banks of gaming devices. This allows gaming device data to be collected from a greater number of banks of gaming devices and allows connections to a central patch panel for a flexible configuration of wiring and cables. This allows for faster and easier troubleshooting and testing of system components. Other aspects of the embodiment shown in FIG. 3 are similar to that shown in FIG. 2 and will not be described in further detail. This configuration allows an entire bank of gaming devices to be removed from the system by unplugging the appropriate cords from the outgoing and return ports of the appropriate RJ-45 connector and placing a standard commercial by-pass cord into the ports. Such by-pass cord can be configured using Panduit® UTPCI78u or equivalent cable.

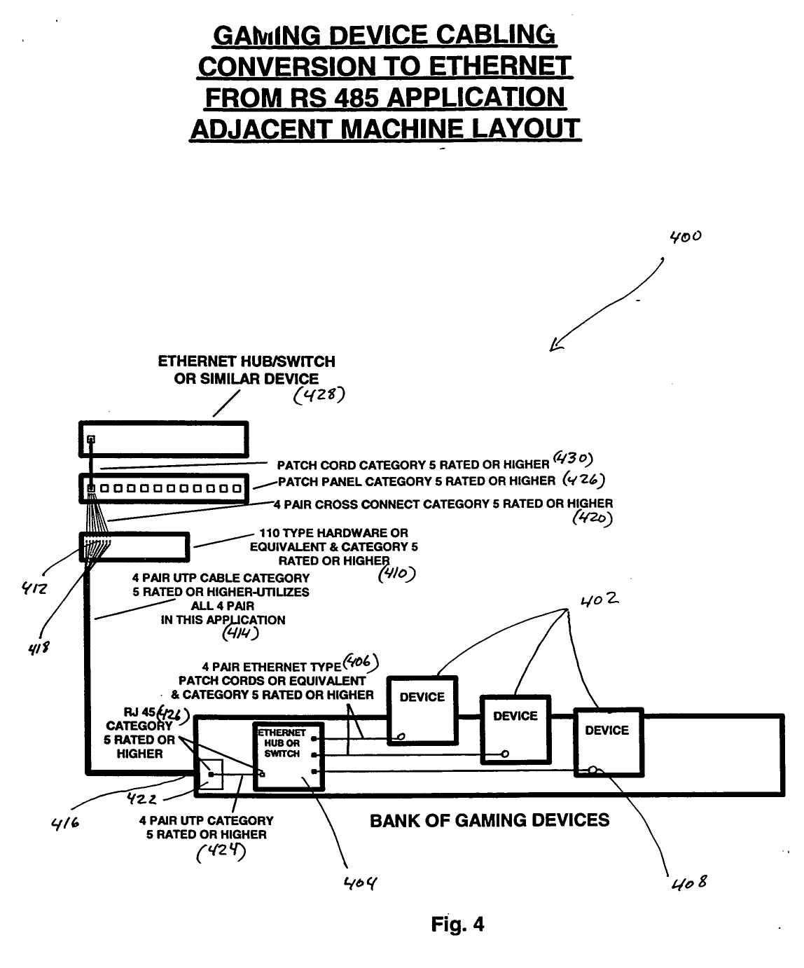

FIG. 4 illustrates another embodiment of a gaming device system designated in its entirety by reference numeral (400) configured for Ethernet transmission applications. This embodiment allows for flexible and efficient installation of many cable and hardware components and data collection from a greater number of gaming devices. The system includes a number of gaming devices (402) arranged in a bank and includes a bank hub (404) connected in parallel to each of the gaming devices for transmitting data from the gaming devices. The bank hub is preferably a commercially available Ethernet hub such as the Cisco® 1538 or equivalent or an Ethernet switch such as Cisco® 2621 or equivalent. The gaming devices are connected to the bank hub by device patch cords (406) having modular connectors (408) such as the RJ-45 or equivalent connectors. The device patch cords are preferably 4-pair Ethernet or equivalent type Category-5-compatible patch cords.

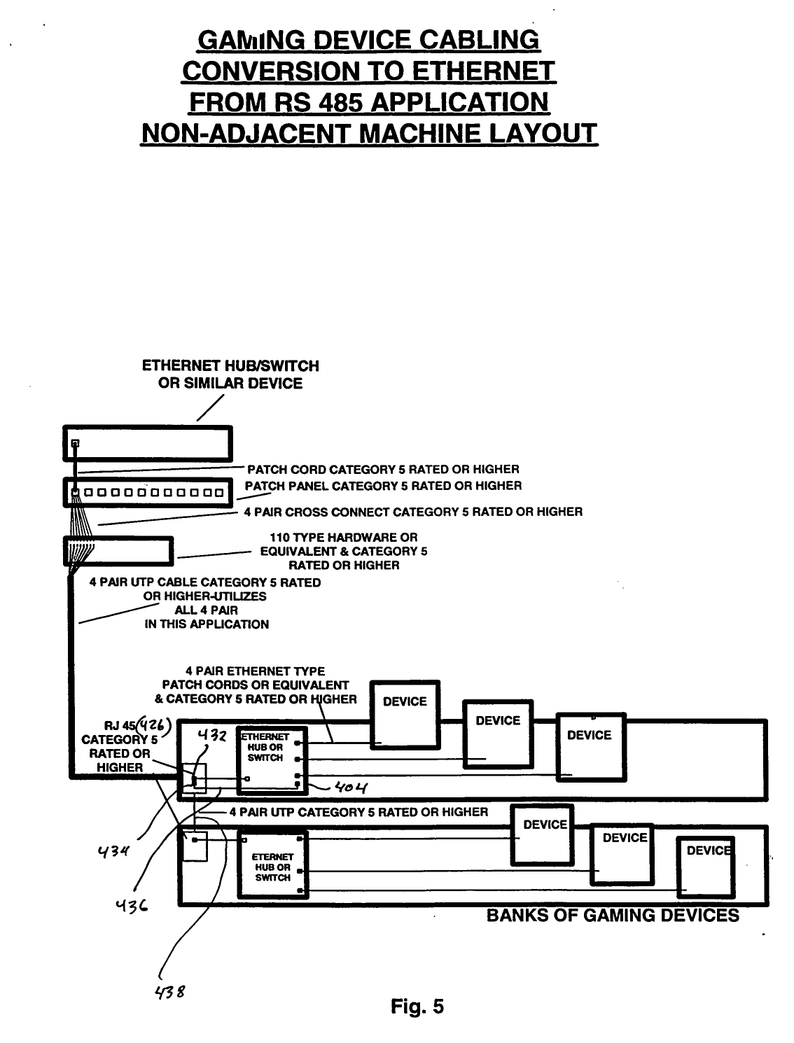

The system includes an insulation displacement connector (410) connected to the bank hub. The insulation displacement connector is preferably a 110-type hardware or equivalent with a Category 5 or higher rating. A commercially available 110-type insulation displacement connector such as Panduite P110 KB1004 or equivalent may be used. The insulation displacement connector has a plurality of, and preferably four, wire pair receptors (412). A twisted pair cable (414) connects the bank hub to the insulation displacement connector. The twisted pair cable is preferably a 4-pair unshielded twisted pair cable and is Category-5-compatible. The four pairs of wires making up the 4-pair unshielded twisted pair cable have a hub end (416) and a system end (418) opposite the hub end (416). The system end (418) of each wire pair is connected to a corresponding wire receptor pair of the insulation displacement connector. A plurality of the wire receptor pairs of the insulation displacement connector are cross-connected to the patch panel using a two or four pair twisted wire (420) with a Category 5 or higher rating. The use of a two pair twisted wire will allow 100 megabit Ethernet communication while the use of a four pair wire will allow faster one gigabit Ethernet communication. All of the pairs of the twisted cable (414) are functioning in the embodiments illustrated in FIGS. 4 and 5.

The hub end (416) of the unshielded twisted pair cable has an RJ-45 modular connector (422) for connecting to the bank hub. The hub end (416) can terminate at a wall, panel or other surface and can have a face plate. A hub patch cord (424) with modular connectors (426) connects the RJ-45 modular connector (422) and the bank hub. The RJ-45 modular connector is preferably Category-5-compatible. The RJ-45 modular connector can be mounted and housed in a surface mount box such as Panduit® JPB1IW or equivalent.

The system includes a patch panel (426) operatively connected to the insulation displacement connector for transmitting gaming device data from the insulation displacement connector to the system hub (428). The patch panel preferably is Category-5-compatible. A commercially available patch panel such as the Panduit® DP485E8810u may be used.

A system level patch cord (430) connects the patch panel to the system hub (428). The system level patch cord is preferably Category-5-compatible. A commercially available patch cord such as the Panduit®UTPCI78u may be used. The system hub (428) is preferably a commercially available Ethernet hub such as Cisco® 1538 or an Ethernet switch such as Cisco® 2621 or equivalent. The system hub collects revenue, player card identification, and other data transmitted by the gaming devices. The data system hub transmits the gaming device data to a tracking device (not shown) such as a computer that compiles the gaming device data into pre-programmed databases.

It will be readily apparent to those skilled in the art that an entire bank can be removed from the system by unplugging the hub patch cord (424) from the RJ-45 modular connector. It is also readily apparent that because of the parallel configuration of the gaming devices and the bank hub, a single gaming device can be taken off-line without affecting the data transmission of the rest of the gaming devices in the bank. To accomplish this, the device patch cord of the appropriate gaming device is unplugged from the bank hub. The gaming device can them be repaired if it is broken or replaced by a more popular gaming device.

It will also be readily apparent to those skilled in the art that the RS-485 system illustrated in FIG. 2 can be easily converted into an Ethernet system such as illustrated in FIG. 4. To accomplish this, a bank hub is connected to the RJ-45 modular connector with a hub patch cord (424) and the gaming devices are connected to the bank hub with device patch cords (406). An appropriate connection is also made between the wire receptors of the insulation displacement device and the patch panel converting it to a two or four pair twisted wire connection.

As illustrated in FIG. 5, multiple bank hubs may be configured into a bank hub daisy-chain allowing multiple bank hubs connected in series to transmit data to the system hub. In this embodiment, the RJ-45 modular connector (426) has an outgoing jack (432) and a return jack (434). A return patch cord (436) connects the bank hub (404) with the return jack. An interbank cable (438) connects the return jack of one RJ-45 connector with the outgoing jack (432) of another RJ-45 connector associated with a separate bank hub. Preferably the interbank cable runs behind the face plates of the RJ-45 connectors that is mounted in a surface mount box. The return patch cord and the interbank cable are preferably 4-pair unshielded twisted pair cables. The return patch cord, the RJ-45 connector, and the interbank cable are preferably Category-5-compatible. Other aspects of this embodiment are similar to that described with respect to FIG. 4 and will not be described in further detail.

The system illustrated in FIG. 5, allows a single device to be removed by disconnecting the device patch cord from the bank hub. Alternatively, an entire bank of gaming devices to be removed from the system by unplugging the appropriate cords from the outgoing and return jack of the appropriate RJ-45 connector and placing a standard commercial by-pass cord (not shown) into the jacks. Such by-pass cord can be configured using Panduit® UTPCI78u or equivalent cable.

It will be readily apparent to those skilled in the art that a patch panel can be configured to connect to multiple twisted pair wires associated with multiple insulation displacement connectors connected to banks of gaming devices. This allows gaming device data to be collected from a greater number of banks of gaming devices and allows connections to a central patch panel for a flexible configuration of wiring and cables. This allows for faster and easier troubleshooting and testing of system components.

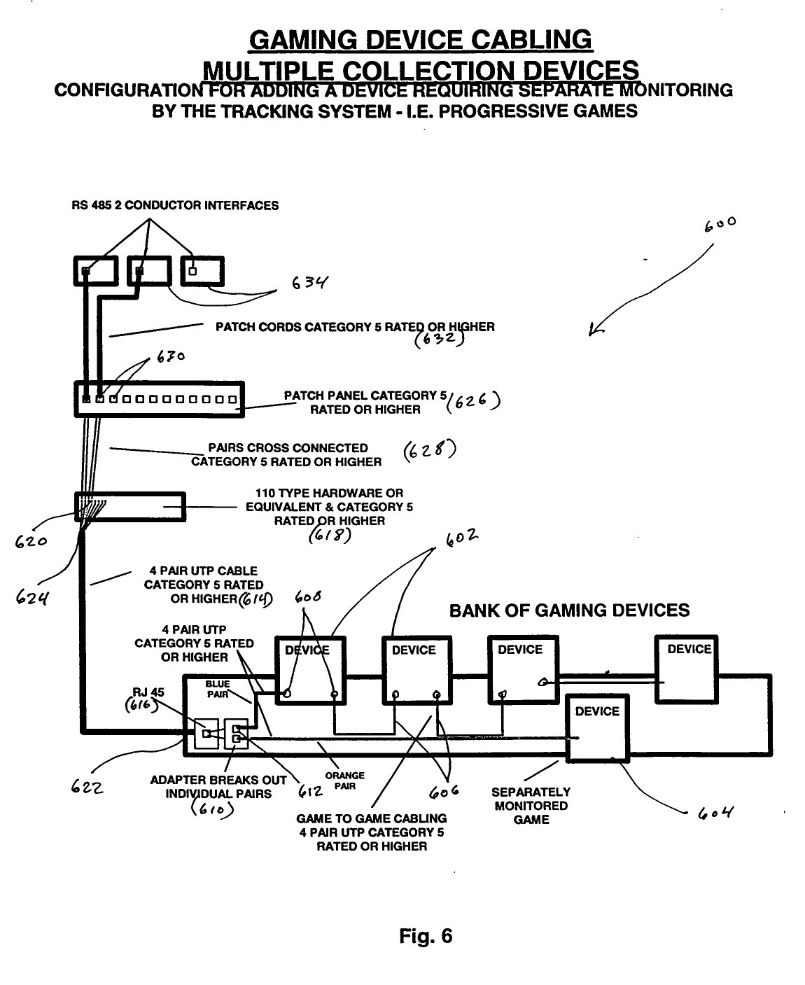

FIG. 6 illustrates an embodiment of a gaming device system designated in its entirety by the reference numeral (600) configured for data collection from a bank of gaming devices and a separately monitored gaming device.

The system includes a plurality of gaming devices (602) arranged in a bank and connected in series, and a separately monitored gaming machine (604). The gaming devices in the bank are connected using device patch cords (606) with modular connectors (608). The device patch cords and modular connectors are preferably Category-5-compatible. The modular connectors (608) may be Molex® multi-pin connectors or equivalent type connectors. The gaming devices and the separately monitored gaming machine are connected to an RJ-45 adapter (610) that has two connectors (612). The bank of gaming devices is attached to one connector and the separately monitored gaming device to another. The adapter (610) functions to break out the individual pairs of the twisted pair cable (614) such that data transmitted by the bank of gaming devices is carried on one wire pair and the data transmitted by the separately monitored gaming device on another wire pair. A commercially available adapter such as Siemons® YTP-u2-u2 or equivalent may be used. The adapter (610) is connected to an RJ-45 modular connector (616) that is mounted or housed in a surface mount box such as Panduit® qJPB1IW or equivalent.

The RJ-45 modular connector (616) is connected to a twisted pair cable (614) that connects the bank of gaming devices and the separately monitored gaming device to an insulation displacement connector (618). The twisted pair cable is preferably a 4-pair unshielded twisted pair cable and is Category-5-compatible. The insulation displacement connector (618) is preferably a 110-type hardware or equivalent is Category-5-compatible. A commercially available 110-type insulation displacement connector such as Panduit® P11 0 KB1004 or equivalent may be used. The insulation displacement connector has a plurality of, and preferably four, wire pairs receptor (620).

The four pairs of wires making up the twisted pair cable (614) have a device end (622) and a system end (624) opposite the device end (622). The RJ-45 modular connector (616) is connected to the device end (622) of the unshielded twisted pair cable. The device end (622) can terminate at a wall, panel or other surface and can have a face plate. The system end (624) of at least one, and preferable two, wire pairs is connected to a corresponding wire receptor pair (620) of the insulation displacement connector. At least one, and preferably two of the wire receptor pairs of the insulation displacement connector are cross connected to a patch panel (626) using paired twisted wires (628) that are Category-5-compatible. The patch panel is preferably Category-5-compatible. A commercially available patch panel such as the Panduit® DP485E8810u may be used. The patch panel includes a plurality of modular connectors (630). A plurality of system level patch cords (632) connects each modular connector of the patch panel to a corresponding collection device (634). The system level patch cord is preferably Category-5-compatible. A commercially available patch cord such as the Panduite UTPCI78u or equivalent may be used. Two pairs of the 4-pair unshielded twisted cable (614) are idle in the embodiment illustrated in FIG. 6 and may be separated from the twisted pair cable and used for additional applications.

Consequently, the data from the bank of gaming devices and the separately monitored gaming device is routed to separate collection devices and is compiled separately by the tracking device.

It will be apparent to those skilled in the art that previously illustrated embodiments can be converted to this embodiment and vice versa by appropriately reconfiguring the system level patch cords, cross connecting wire pairs between the insulation displacement connector and the patch panel modular connectors, and by plugging appropriate device patch cords or adapters into the RJ-45 modular connector.

It will also be apparent to those skilled in the art that the embodiment illustrated in FIG. 6 can be configured to connect additional banks of gaming devices to the modular connectors of the patch panel that can in turn be connected to appropriate RS-485 collections devices or Ethernet system hubs. Thus the embodiment in FIG. 6 can be configured to simultaneously collect data using the RS-485 and Ethernet standards from separate banks of gaming devices and separately monitored gaming devices.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense.

What is claimed is:

1. A gaming device system comprising:
a plurality of gaming devices arranged in a bank;
a bank hub operatively connected to each of said gaming devices in the bank for receiving data from each of said gaming devices;
a system hub operatively connected to said bank hub for receiving data from the bank hub; and
a tracking device operatively connected to said system hub for receiving data from the system hub, thereby collecting data from said gaming devices.

2. A system as set forth in claim 1 wherein said bank and system hubs comprise ethernet-compatible hubs.

3. A system as set forth in claim 1 further comprising:
a insulation displacement connector operatively connected to said bank hub for receiving data from said bank hub; and
a patch panel operatively connected to said insulation displacement connector for receiving data from said insulation displacement connector and transmitting said data to said system hub.

4. A system as set forth in claim 3 further comprising a system level patch cord connecting said patch panel to said system hub.

5. A system as set forth in claim 4 wherein said system level patch cord comprises a category-5-compatible modular connector patch cord.

6. A system as set forth in claim 3 further comprising an unshielded twisted pair cable connecting said bank hub to said insulation displacement connector.

7. A system as set forth in claim 6 wherein said unshielded twisted pair cable comprises a 4 pair category-5-compatible cable.

8. A system as set forth in claim 6 wherein:
said insulation displacement connector includes a plurality of wire receptors; and
said unshielded twisted pair cable comprises a plurality of wires, each of said wires extending from a hub end to a system end opposite said hub end, each of said system ends being connected to at least one of said wire receptors of said insulation displacement connector.

9. A system as set forth in claim 8 wherein the hub end of at least one of said wires is connected to an RJ-45 category-5-compatible modular connector.

10. A system as set forth in claim 8 wherein said patch panel has a plurality of modular panel connectors and at least a portion of said insulation displacement connector wire receptors are cross-connected to at least a portion of said modular panel connectors.

11. A system as set forth in claim 3 further comprising a plurality of bank level patch cords, each of said cords connecting at least one of said plurality of gaming devices to said bank hub.

12. A system as set forth in claim 11 wherein each of said bank level patch cords comprises a category-5-compatible modular connector patch cord.

13. A system as set forth in claim 1 wherein:
said plurality of gaming devices arranged in the bank are a first plurality of gaming devices arranged in a first bank;
said bank hub is a first bank hub;
said system further comprises:
a second plurality of gaming devices arranged in a second bank; and
a second bank hub operatively connected to each of said gaming devices in said second bank for receiving data from each of said gaming devices; and
the system hub is operatively connected to said second bank hub for receiving data from the second bank hub.

14. A gaming device system comprising:
a first plurality of gaming devices arranged in a first bank;
a second plurality of gaming devices arranged in a second bank;
a first bank hub operatively connected to each of said gaming devices in said first bank for receiving data from each of said first plurality of gaming devices;
a second bank hub operatively connected to each of said gaming devices in said second bank for receiving data from each of said second plurality of gaming devices;
a system hub operatively connected to each of said first and second bank hubs for receiving data from said first and second bank hubs; and
a tracking device operatively connected to said system hub for receiving data from the system hub, thereby collecting data from said first and second pluralities of gaming devices.

15. A system as set forth in claim 14 wherein said first and second bank hubs and said system hub comprise ethernet-compatible hubs.

16. A system as set forth in claim 14 further comprising:
a insulation displacement connector operatively connected to said first and second bank hubs for receiving data from each of said first and second bank hubs; and
a patch panel operatively connected to said insulation displacement connector for receiving data from said insulation displacement connector and transmitting said data to said system hub.

17. A system as set forth in claim 16 further comprising a system level patch cord connecting said patch panel to said system hub.

18. A system as set forth in claim 17 wherein said system level patch cord comprises a category-5-compatible modular connector patch cord.

19. A system set forth in clam 16 further comprising an unshielded twisted pair cable connecting said first and second bank hubs to said insulation displacement connector.

20. A system as set forth in claim 19 wherein said unshielded twisted pair cable comprises a 4 pair category-5-compatible cable.

21. A system as set forth in claim 19 wherein:
said insulation displacement connector includes a plurality of wire receptors; and
said unshielded twisted pair cable comprises a plurality of wires, each of said wires extending from a hub end to a system end opposite said hub end each of said system ends being connected to at least one of said wire receptors of said insulation displacement connector.

22. A system as set forth in claim 21 wherein the hub end of at least one of said wires is connected to an RJ-45 category-5-compatible modular connector.

23. A system as set forth in claim 22 wherein said RJ-45 category-5-compatible modular connector is a first RJ-45 category-5-compatible modular connector operatively connected to said first bank hub; and said system further comprises a second RJ-45 category-5-compatible modular connector operatively connected to said first RJ-45 category-5-compatible modular connector and to said second bank hub.

24. A system as set forth in claim 23 further comprising an interbank unshielded twisted pair cable connecting said first and second RJ-45 category-5-compatible modular connectors.

25. A system as set forth in claim 24 wherein said interbank unshielded twisted pair cable comprises a 4 pair category-5-compatible cable.

26. A system as set forth in claim 21 wherein said patch panel has a plurality of modular connectors and at least a portion of said insulation displacement connector wire receptors are cross-connected to at least a portion of said patch panel connectors.

27. A system as set forth in claim 16 further comprising:
a first plurality of device patch cords, each of said first plurality of patch cords connecting at least one of said first plurality of gaming devices to said first bank hub; and
a second plurality of device patch cords, each of said second plurality of patch cords connecting as least one of said second plurality of gaming devices to said second bank hub.

28. A gaming device system comprising:
a plurality of gaming devices arranged in a bank and connected in series;
a separately monitored gaming device capable of transmitting data;
an insulation displacement connector operatively connected to each of said plurality of gaming devices in said bank and to said separately monitored gaming device for receiving data from said plurality of gaming devices and said separately monitored gaming device;
a patch panel operatively connected to said insulation displacement connector for receiving data from said insulation displacement connector;
a plurality of data collection devices operatively connected to said patch panel for receiving data from said plurality of gaming devices and said separately monitored gaming device; and
a tracking device operatively connected to each of said plurality of data collection devices for receiving data from the data collection devices, thereby collecting data from said plurality of gaming devices and said separately monitored gaming device.

29. A system as set forth in claim 28 further comprising a plurality of system level patch cords, each of said plurality of system level patch cords connecting said patch panel with at least one of said plurality of data collection devices.

30. A system as set forth in claim 29 wherein each of said plurality of system level patch cords comprises a category-5-compatible connector patch cord.

31. A system as set forth in claim 30 further comprising an unshielded twisted pair cable connecting said plurality of gaming devices and said separately monitored gaming device to said insulation displacement connector.

32. A system as set forth in claim 31 wherein said unshielded twisted pair cable comprises a 4 pair category-5-compatible cable.

33. A system as set forth in claim 31 wherein:
said insulation displacement connector has a plurality of wire receptors;
said unshielded twisted pair cable comprises a plurality of wires, each of said wires extending from a device end to a system end opposite said device end; and
the system end of each of said wires is connected to at least one of said wire receptors of said insulation displacement connector.

34. A system as set forth in claim 33 wherein the device end of at least one of said wire pairs is connected to an RJ 45 category-5-compatible modular connector.

35. A system as set forth in claim 33 wherein said patch panel has a plurality of modular panel connectors and at least a portion of said insulation displacement connector wire receptors are cross-connected to at least a portion of said modular panel connectors.

36. A system as set forth in claim 35 wherein each wire receptors of said insulation displacement connector is connected to a corresponding modular panel connector of said patch panel.

37. A system as set forth in claim 33 further comprising:
an RJ 45 category-5-compatible module connector, the device ends of each of said wires being connected to said RJ 45 connector.

38. A system as set forth in claim 37 further comprising an adapter connected to the RJ 45 connector for connecting the plurality of gaming devices and said separately monitored gaming device to the RJ 45 connector.

39. A method for converting a gaming device system including a bank of gaming devices connected to a modular connector, an insulation displacement connector having a plurality of pairs of wire receptors connected to said modular connector, a patch panel connected to at least one of said pairs of wire receptors, a collection device operatively connected to said patch panel, and a tracking device operatively connected to said collection device, said method comprising:
disconnecting said bank of gaming devices from said modular connector;
connecting the modular connector to a bank hub connected to at least one gaming device;
cross-connecting each of said pairs of wire receptors of said insulation displacement connector to said patch panel;
connecting said patch panel to a system hub; and
connecting said system hub to said tracking device.

40. A method as set forth in claim 39 wherein said bank and system hubs comprise ethernet-compatible hubs.

41. A method for converting a gaming device system including a plurality of banks of gaming devices connected to a plurality of modular connectors, an insulation displacement connector having a plurality of pairs of wire receptors connected to said plurality of modular connectors, a patch panel connected to at least one of said pairs of wire receptors, a collection device operatively connected to said patch panel, and a tracking device operatively connected to said collection device, said method comprising:
disconnecting each of said plurality of banks of gaming devices from said plurality of modular connectors;
connecting at least one of said plurality of modular connectors to a bank hub connected to at least one gaming device;
cross-connecting each of said pairs of wire receptors of said insulation displacement connector to said patch panel;
connecting said patch panel to a system hub; and
connecting said system hub to said tracking device.

42. A method as set forth in claim 41 wherein said bank and system hubs comprise ethernet-compatible hubs.

43. A method for converting a gaming device system including a bank of gaming devices connected to a modular connector, an insulation displacement connector connected to said modular connector, said insulation displacement connector having a plurality of pairs of wire receptors, a patch panel including a plurality of panel connectors, at least one of said panel connectors connected to at least one of said pairs of wire receptors, a collection device operatively connected to said patch panel, and a tracking device operatively connected to said collection device, said method comprising:
disconnecting said bank of gaming devices from said modular connector;
connecting a modular adapter to said modular connector, said modular adapter having a plurality of connectors;
connecting said bank of gaming devices to one of said plurality of connectors of said adapter;
connecting a separately monitored gaming device to another of said plurality of connectors of said adapter;
connecting said panel connectors to said pairs of wire receptors of said insulation displacement connector so that said bank of gaming devices and said separately monitored gaming device are in communication with separate panel connectors;
connecting a plurality of collection devices to said panel connectors so that said bank of gaming devices and said separately monitored gaming device are in communication with separate collection devices; and
connecting each of said collection devices to a tracking device.

44. A method as set forth in claim 43 further comprising:
connecting at least one of a plurality of pairs of wire receptor of another insulation displacement connector to at least one of said panel connectors of said patch panel, said another insulation displacement connector being operatively connected to another bank of gaming devices; and
connecting a plurality of collection devices to said panel connectors so that each of said banks of gaming devices and said separately monitored gaming device are in communication with separate collection devices; and
connecting each of said collection devices to said tracking device.

45. A method as set forth in claim 44 wherein said another insulation displacement connector is operatively connected to a bank hub, said bank hub being operatively connected to at least one gaming device, said method further comprising:
connecting each of said plurality of pairs of wire receptors of said another insulation displacement connector to one of said panel connectors of said patch panel;
connecting a system hub to said panel connector so that said system hub is in communication with said bank hub; and
connecting said system hub to said tracking device.

46. A method as set forth in claim 45 wherein said bank and system hubs comprise ethernet-compatible hubs.

47. A method of changing devices in a gaming device system including a bank hub having a plurality of gaming device jacks, a plurality of gaming devices connected to said device jacks of said bank hub, said bank hub being in communication with a tracking device, said method comprising:
disconnecting at least one of said gaming devices from said plurality of gaming device jacks thereby allowing the other of said plurality of gaming devices to be connected to said bank hub.
